(19) United States
(12) Patent Application Publication
(10) Pub. No.: US 2025/0354702 A1
(43) Pub. Date: Nov. 20, 2025

(54) INTEGRATED HVAC AND DIRECT CARBON CAPTURE SYSTEM AND METHOD

(71) Applicant: Tyco Fire & Security GmbH, Neuhausen am Rheinfall (CH)

(72) Inventor: Sachin Ghorpade, Navi Mumbai (IN)

(21) Appl. No.: 19/210,861

(22) Filed: May 16, 2025

Related U.S. Application Data
(60) Provisional application No. 63/649,018, filed on May 17, 2024.

(51) Int. Cl. F24F 8/133; B01D 53/14; B01D 53/34; B01D 53/62; B01D 53/78; B01D 53/96

(52) U.S. Cl. CPC F24F 8/133; B01D 53/1412; B01D 53/1425; B01D 53/1475; B01D 53/1493; B01D 53/346; B01D 53/62; B01D 53/78; B01D 53/96; B01D 2252/204; B01D 2257/504; B01D 2258/06; B01D 2259/4508; F24F 2203/021

(57) ABSTRACT

The present disclosure is directed to an HVAC system including a refrigeration circuit and a greenhouse gas removal circuit. The refrigerant circuit includes a first heat exchanger, a second heat exchanger, and at least one conduit configured to direct a refrigerant between the first heat exchanger and the second heat exchanger. The greenhouse gas removal circuit includes a first vessel adjacent to the first heat exchanger, a second vessel adjacent to the second heat exchanger, and at least one additional conduit configured to direct a solvent between the first vessel and the second vessel. The solvent present at the first vessel absorbs or adsorbs greenhouse gas (e.g., CO₂) from a first airflow biased over the first heat exchanger. Heat rejected by the second heat exchanger into a second airflow is used to drive, at the second vessel, separation of the greenhouse gas (e.g., CO₂) from the solvent.

### CROSS-REFERENCE TO RELATED APPLICATIONS

This application claims priority from and the benefit of U.S. Provisional Application Ser. No. 63/649,018, entitled “INTEGRATED HVAC AND DIRECT CARBON CAPTURE SYSTEM AND METHOD,” filed May 17, 2024, which is hereby incorporated by reference in its entirety for all purposes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, and/or air conditioning (HVAC) systems and methods are contributors to greenhouse gas emission, particularly in commercial and industrial settings. In particular, HVAC systems and methods are prone to carbon dioxide (CO₂) emissions. For example, HVAC systems may produce greenhouse gases, such as CO₂, from combustion of hydrocarbon fuels (e.g., oil and/or gasoline), among other sources. Accordingly, it is presently recognized that improved systems and methods which reduce greenhouse gas emissions, such as CO₂ emissions, are desired.

Further, greenhouse gas emissions, such as CO₂ emissions, may reach a space conditioned by an HVAC system in certain traditional configurations. Ventilation air (e.g., outside air) may be employed to dilute the greenhouse gas emissions, such as the CO₂ emissions, in certain traditional configurations. The ventilation air (e.g., the outside air) may deviate from a setpoint characteristic (e.g., a setpoint temperature) by a greater amount than return air. By using a relatively large amount of ventilation air and/or a relatively small amount of return air, a load on the HVAC system may be undesirably large in order to adequately condition the space to the setpoint characteristic (e.g., the setpoint temperature), thereby contributing to an undesirably large operating cost and/or an undesirably low efficiency of the HVAC system. It is presently recognized that improved systems and methods with a higher efficiency and/or a lower operating cost are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an HVAC system including a refrigeration circuit and a greenhouse gas removal circuit. The refrigerant circuit includes a first heat exchanger, a second heat exchanger, and at least one conduit configured to direct a refrigerant between the first heat exchanger and the second heat exchanger. The greenhouse gas removal circuit includes a first vessel adjacent to the first heat exchanger, a second vessel adjacent to the second heat exchanger, and at least one additional conduit configured to direct a solvent between the first vessel and the second vessel. The solvent present at the first vessel absorbs or adsorbs greenhouse gas (e.g., CO₂) from a first airflow biased over the first heat exchanger. Heat rejected by the second heat exchanger into a second airflow is used to drive, at the second vessel, separation of the greenhouse gas (e.g., CO₂) from the solvent.

In another embodiment, a method of operating an HVAC system includes establishing a first heat exchange relationship between a refrigerant present in a first heat exchanger of a refrigeration circuit of the HVAC system and a first airflow generated by a first fan of the HVAC system. The method also includes establishing a second heat exchange relationship between the refrigerant present in a second heat exchanger of the refrigeration circuit and a second airflow generated by a second fan of the HVAC system. The method also includes absorbing or adsorbing, from the first airflow, greenhouse gas via a solvent present in a first vessel of a greenhouse gas removal circuit of the HVAC system, wherein the first vessel is adjacent to the first heat exchanger. The method also includes biasing the solvent laden with the greenhouse gas to a second vessel of the greenhouse gas removal circuit, wherein the second vessel is adjacent to the second heat exchanger. The method also includes separating the greenhouse gas from the solvent at the second vessel via heat rejected by the second heat exchanger and present in the second airflow.

In another embodiment, an HVAC system includes a heat exchanger a fan configured to direct an airflow over the heat exchanger, and a vessel positioned adjacent to the heat exchanger such that the vessel receives the airflow and absorbs or adsorbs a greenhouse gas in a solid solvent present in the vessel.

### BRIEF DESCRIPTION OF THE DRAWINGS

Various aspects of this disclosure may be better understood upon reading the following detailed description and upon reference to the drawings in which:

FIG. 1 is a perspective view of an embodiment of a heating, ventilation, and/or air conditioning (HVAC) system for building environmental management that may employ one or more HVAC units, in accordance with an aspect of the present disclosure;

FIG. 2 is a perspective view of an embodiment of an HVAC unit that may be used in an HVAC system, in accordance with an aspect of the present disclosure;

FIG. 3 is a perspective view of an embodiment of a residential split heating and cooling system that may be used in an HVAC system, in accordance with an aspect of the present disclosure;

FIG. 4 is a schematic view of an embodiment of a vapor compression system that may be used in an HVAC system, in accordance with an aspect of the present disclosure;

FIG. 5 is a schematic view of an embodiment of an HVAC system including a vapor compression system (e.g., a refrigeration circuit) operating in a normal operating mode, and including a greenhouse gas removal circuit configured to bias a solvent between a first vessel (e.g., an absorber or adsorber vessel) and a second vessel (e.g., a stripper vessel), in accordance with an aspect of the present disclosure;

FIG. 6 is a schematic view of an embodiment of an HVAC system including a vapor compression system (e.g., a refrigeration circuit) operating in a heat pump operating mode, and including a greenhouse gas removal circuit configured to bias a solvent between a first vessel (e.g., an absorber or adsorber vessel) and a second vessel (e.g., a stripper vessel), in accordance with an aspect of the present disclosure;

FIG. 7 is a schematic view of an embodiment of an HVAC system including a heat exchanger of a vapor compression system (e.g., a refrigeration system) and a solid solvent vessel, in accordance with an aspect of the present disclosure; and

FIG. 8 is a process flow diagram illustrating an embodiment of a method of operating an HVAC system including a vapor compression system (e.g., a refrigeration circuit) and a greenhouse gas removal circuit, in accordance with an aspect of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

Embodiments of the present disclosure relate to heating, ventilation, and/or air conditioning (HVAC) systems that reduce greenhouse gas emissions, such as carbon dioxide (CO₂) emissions, improve efficiency, and/or reduce operating costs relative to traditional configurations. For example, an embodiment of the HVAC system may include a vapor compression system, referred to in certain instances of the present disclosure as a refrigeration circuit, having a first heat exchanger, a second heat exchanger, a compressor, an expansion valve, and at least one conduit configured to direct a refrigerant (e.g., by operation of the compressor) through the refrigeration circuit, among other possibly componentry. In some embodiments, the HVAC system may transition between a normal operating mode and a heat pump operating mode by reversing a flow direction of the refrigerant through the refrigeration circuit, such that the first heat exchanger operates as an evaporator in the normal operating mode and a condenser in the heat pump operating mode, and such that the second heat exchange operates as the condenser in the normal operating mode and the evaporator in the heat pump operating mode. In both the normal and heat pump operating modes, a first fan (referred to in certain instances of the present disclosure as a first blower) may be configured to direct a first airflow over the first heat exchanger to establish a first heat exchange relationship between the first airflow and the refrigerant within the first heat exchanger, and a second fan (referred to in certain instances of the present disclosure as a second blower) may be configured to direct a second airflow over the second heat exchanger to establish a second heat exchange relationship between the second airflow and the refrigerant within the second heat exchanger.

Further, the HVAC system may include a greenhouse gas removal circuit having a first vessel (e.g., an absorber or adsorber vessel) disposed adjacent to the first heat exchanger (e.g., downstream of the first heat exchanger relative to a first flow direction of the first airflow), a second vessel (e.g., a stripper vessel) disposed adjacent to the second heat exchange (e.g., downstream from the second heat exchanger relative to a second flow direction of the second airflow), a pump, and at least one additional conduit configured to direct a solvent (e.g., by operation of the pump) through the greenhouse gas removal circuit. The solvent may include, for example, a liquid solvent, such as an amine-based solvent. Greenhouse gas (e.g., CO₂) present in the first airflow, for example, may be adsorbed or absorbed by the solvent present at the first vessel (e.g., absorber or adsorber vessel) via a chemical process. In some embodiments, this chemical process includes transitioning the CO₂, for example, to liquid form. The solvent, now laden with the CO₂, for example, may be directed to the second vessel. The second vessel may be configured to separate the greenhouse gas (e.g., CO₂) from the solvent by way of heat rejected from the second heat exchanger of the refrigeration circuit via the second airflow and to the second vessel. For example, the heat may separate the greenhouse gas (e.g., CO₂) from the solvent. For example, in some embodiments, the CO₂ may include a boiling temperature that is less than that of the solvent. The greenhouse gas (e.g., CO₂) separated from the solvent may be removed via a removal pathway (e.g., a removal conduit) and directed toward a storage facility (e.g., a storage vessel, a third vessel). In some embodiments, a greenhouse gas compressor is employed to compress the greenhouse gas (e.g., CO₂) separated from the solvent. Accordingly, the greenhouse gas (e.g., CO₂), such as the compressed greenhouse gas (e.g., CO₂), may be stored in the storage facility (e.g., storage vessel, third vessel) for future use or processing.

As previously described, the HVAC system may operate as a heat pump, whereby the roles of the first heat exchanger and the second heat exchanger may be reversed between the normal operating mode and the heat pump operating mode by reversing the flow direction of the refrigerant (e.g., via a reversing valve of the refrigeration circuit). Likewise, an additional flow direction of the solvent in the greenhouse gas removal circuit may be reversed in response to the reversing of the flow direction of the refrigerant (e.g., in response to a switching of the HVAC system between the normal operating mode and the heat pump operating mode). In this way, the greenhouse gas removal circuit may be capable of removing and storing greenhouse gas (e.g., CO₂) during the normal operating mode of the HVAC system and the heat pump operating mode of the HVAC system. In some embodiments, roles of the first vessel and the second vessel of the greenhouse gas removal circuit may be reversed between the normal operating mode of the HVAC system and the heat pump operating mode of the HVAC system. For example, in some embodiments, the first vessel may operate as the absorbing vessel in the normal operating mode and as the stripper in the heat pump operating mode, while the second vessel may operate as the stripper in the normal operating mode and the absorber or adsorber vessel in the heat pump operating mode.

Other embodiments of the present disclosure, described in greater detail with reference to the drawings, may include a solid solvent vessel having a solid solvent therein, where the solid solvent vessel is positioned adjacent to the first heat exchanger (e.g., the evaporator) of the HVAC system and configured to receive the first airflow biased over the first heat exchanger. The solid solvent may absorb or adsorb greenhouse gas (e.g., CO₂) produced by the HVAC system and/or present in the first airflow via a chemical process. In some embodiments, the solid solvent vessel includes a sensor configured to detect a saturation level at which the solid solvent is saturated with or by the CO₂, for example. A controller may receive, from the sensor, sensor feedback indicative of the saturation level. In some embodiments, the controller transmits a signal in response to the saturation level exceeding a threshold saturation level, alerting an operator that the solid solvent vessel requires maintenance (e.g., removal of the CO₂. for example, from the solid solvent within the solid solvent vessel). Additionally or alternatively, the solid solvent vessel may be equipped with a heater that, upon initiation, heats the solid solvent such that the greenhouse gas is separated from the solid solvent for removal from the solid solvent vessel to a storage facility (e.g., storage vessel, third vessel). Other embodiments and/or features are also possible and described in greater detail with reference to the drawings.

In general, presently disclosed embodiments reduce greenhouse gas emissions, such as CO₂ emissions, that may be produced by HVAC systems from combustion of hydrocarbon fuels (e.g., oil and/or gasoline), among other possible sources. Further, by reducing greenhouse gas emissions, such as CO₂ emissions, an amount of greenhouse gas emissions that could reach the conditioned space may be reduced relative to traditional configurations, thereby reducing an amount of ventilation air (e.g., outside air) used for purposes of ventilation (e.g., for purposed of diluting the greenhouse gas emissions in the conditioned space) relative to traditional configurations. By reducing the amount of ventilation air (e.g., outside air) used by the HVAC system relative to traditional configurations, a load placed on the HVAC system for conditioning the space (e.g., for reaching a setpoint characteristic, such as a setpoint temperature) may be reduced relative to traditional configurations, thereby improving an efficiency and/or reducing an operating cost of the HVAC system relative to traditional configurations. These and other aspects of the present disclosure are described in detail below with reference to the drawings.

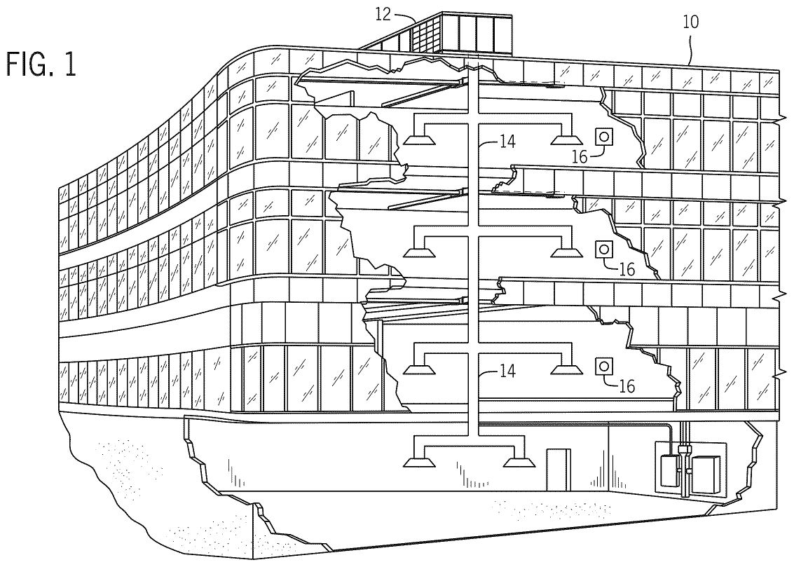

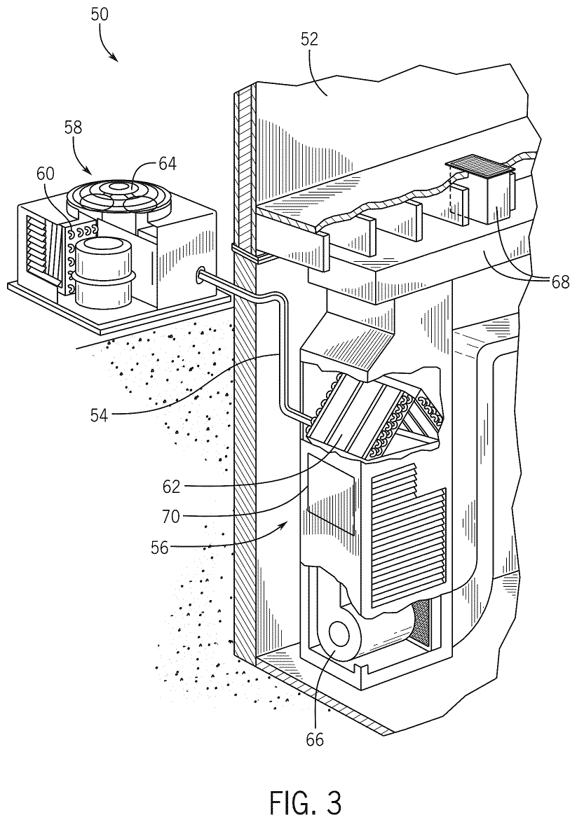

Turning now to the drawings, FIG. 1 illustrates an embodiment of a heating, ventilation, and/or air conditioning (HVAC) system for building environmental management that may employ one or more HVAC units. The HVAC system of FIG. 1 may also employ present embodiments to limit overflow of condensate into ductwork. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air-cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream. A heat exchanger of the HVAC unit 12, such as one in a refrigeration circuit, may cause generation of condensate that is collected and removed in accordance with embodiments of the presently disclosed drain system and shield.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

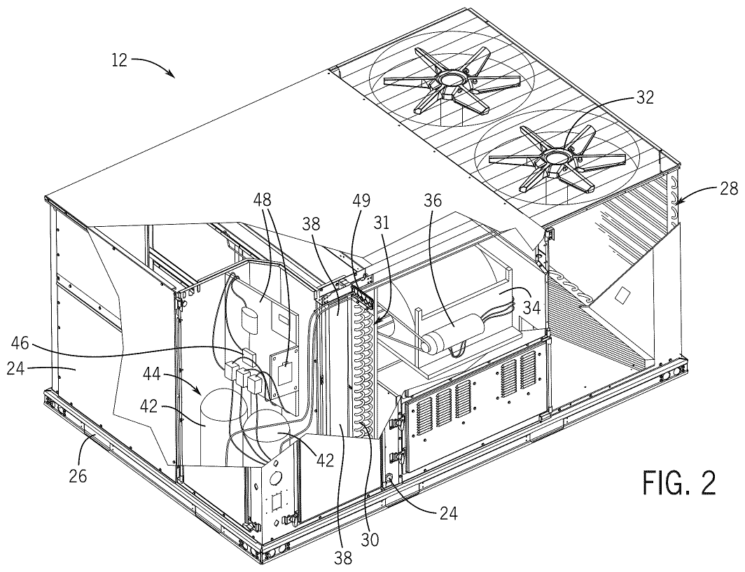

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Such heat exchangers may cause accumulation of condensate from environmental air that is addressed by embodiments of the presently disclosed drainage system. Tubes within the heat exchangers 28 and 30 may circulate a working fluid, such as R-410A, through the heat exchangers 28 and 30. The tubes may be of various types, such as multichannel tubes, microchannel tubes, conventional copper or aluminum tubing, and so forth. Together, the heat exchangers 28 and 30 may implement a thermal cycle in which the working fluid undergoes phase changes and/or temperature changes as it flows through the heat exchangers 28 and 30 to produce heated and/or cooled air. For example, the heat exchanger 28 may function as a condenser where heat is released from the working fluid to ambient air, and the heat exchanger 30 may function as an evaporator where the working fluid absorbs heat to cool an air stream. In other embodiments, the HVAC unit 12 may operate in a heat pump operating mode where the roles of the heat exchangers 28 and 30 may be reversed. For example, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the working fluid before the working fluid enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates an embodiment of a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by the residential heating and cooling system 50 may include working fluid conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The working fluid conduits 54 transfer working fluid between the indoor unit 56 and the outdoor unit 58, typically transferring primarily liquid working fluid in one direction and primarily vaporized working fluid in an opposite direction.

When the system shown in FIG. 3 is operating as an air conditioner, a heat exchanger 60 in the outdoor unit 58 serves as a condenser for re-condensing vaporized working fluid flowing from the indoor unit 56 to the outdoor unit 58 via one of the working fluid conduits 54. In these applications, a heat exchanger 62 of the indoor unit functions as an evaporator. Specifically, the heat exchanger 62 receives liquid working fluid, which may be expanded by an expansion device, and evaporates the working fluid before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the heat exchanger 62, where the air is cooled when the system is operating in air conditioning mode. Thereafter, the air is passed through ductwork 68 that directs the air to the residence 52. In accordance with present embodiments, the indoor unit 56 includes a drain system in accordance with the present disclosure to limit or block condensate generated by cooling of atmospheric air, for example, from entering the ductwork 68. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of the heat exchangers 60 and 62 are reversed. For example, the heat exchanger 60 of the outdoor unit 58 will serve as an evaporator to evaporate working fluid and thereby cool air entering the outdoor unit 58 as the air passes over the heat exchanger 60. The heat exchanger 62 will receive a stream of air blown over it and will heat the air by condensing the working fluid.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from the heat exchanger 62, such that air directed by the blower 66 passes over the tubes or pipes and extracts heat from the combustion products. The heated air may then be routed from the furnace system 70 to the ductwork 68 for heating the residence 52.

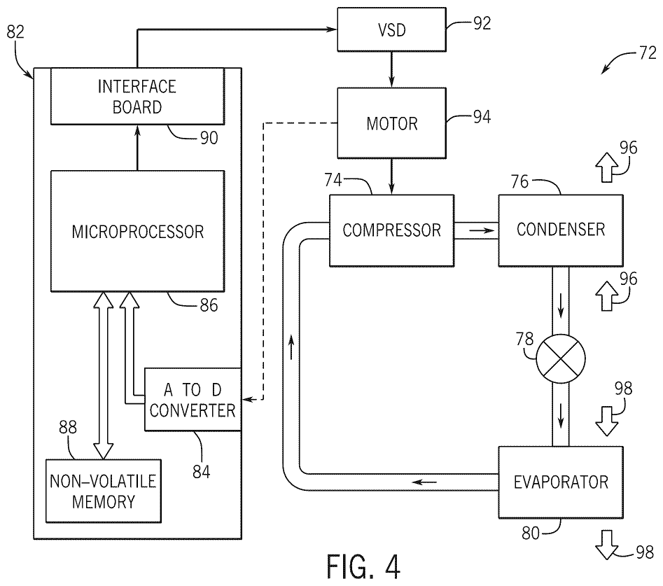

FIG. 4 is an embodiment of a vapor compression system 72 that can be used in any of the systems described above and incorporates one or more drainage system in accordance with present embodiments. The vapor compression system 72 may circulate a working fluid through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a working fluid vapor and delivers the vapor to the condenser 76 through a discharge passage. In some embodiments, the compressor 74 may be a centrifugal compressor. The working fluid vapor delivered by the compressor 74 to the condenser 76 may transfer heat to a fluid passing across the condenser 76, such as ambient or environmental air 96. The working fluid vapor may condense to a working fluid liquid in the condenser 76 as a result of thermal heat transfer with the environmental air 96. The liquid working fluid from the condenser 76 may flow through the expansion device 78 to the evaporator 80.

The liquid working fluid delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid working fluid in the evaporator 80 may undergo a phase change from the liquid working fluid to a working fluid vapor. In this manner, the evaporator 80 may reduce the temperature of the supply air stream 98 via thermal heat transfer with the working fluid. Thereafter, the vapor working fluid exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

Further, in accordance with the present disclosure, any of the systems and/or units in FIGS. 1-4 may include greenhouse gas removal features (e.g., a greenhouse gas removal circuit, a solid solvent vessel configured to absorb or adsorb greenhouse gas, etc.) configured to remove greenhouse gas (e.g., CO₂) produced by the systems and/or units and present in an airflow (e.g., an airflow biased over a heat exchanger of the systems and/or units). These and other aspects of the present disclosure are described in detail below.

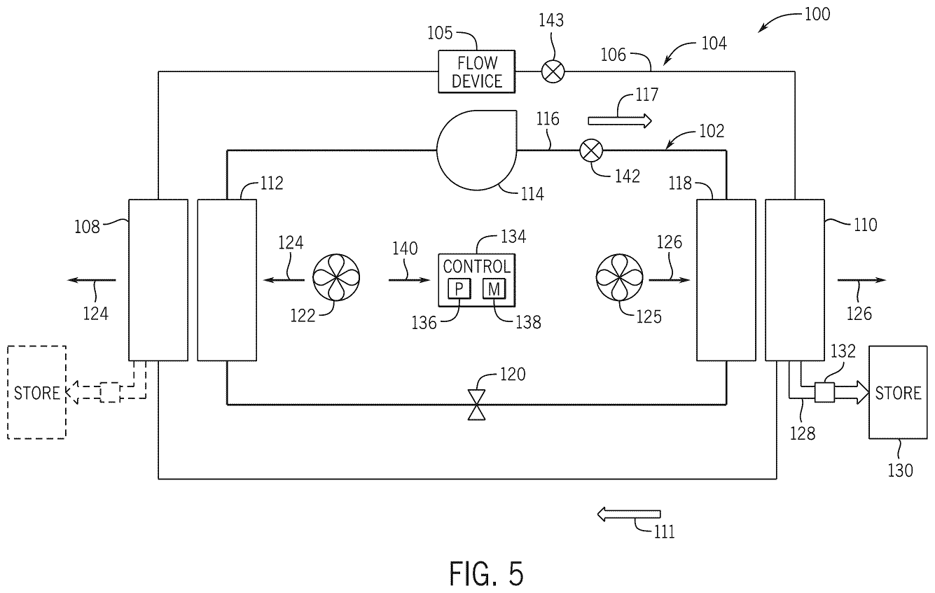

FIG. 5 is a schematic view of an embodiment of an HVAC system 100 including a vapor compression system, referred to below as a refrigeration circuit 102 (e.g., working fluid circuit), operating in a normal operating mode, and including a greenhouse gas removal circuit 104 configured to direct, via operation of a flow device 105 (e.g., a pump), a solvent 106 (e.g., a liquid solvent, such as an amine-based solvent) between a first vessel 108 (e.g., absorber, adsorber vessel) and a second vessel 110 (e.g., stripper vessel). As shown, the flow device 105 may bias (e.g., drive flow of) the solvent in a first solvent flow direction 111 between the first vessel 108 and the second vessel 110. Further, the refrigeration circuit 102 in the illustrated embodiment includes a first heat exchanger 112 (e.g., an evaporator during a normal operating mode of the HVAC system 100), a compressor 114 configured to circulate a refrigerant 116 (e.g., working fluid) along the refrigeration circuit 102 (e.g., in a first refrigerant flow direction 117), a second heat exchanger 118 (e.g., a condenser during a normal operating mode of the HVAC system 100), and an expansion valve 120. The HVAC system 100 also includes a first fan 122 (referred to in certain instances of the present disclosure as a first blower) configured to force a first airflow 124 over and/or across the first heat exchanger 112 to establish a first heat exchange relationship between the first airflow 124 and the refrigerant 116 present in the first heat exchanger 112, and a second fan 125 (referred to in certain instances of the present disclosure as a second blower) configured to force a second airflow 126 over and/or across the second heat exchanger 118 to establish a second heat exchange relationship between the second airflow 126 and the refrigerant 116 present in the second heat exchanger 118.

As shown, the first vessel 108 is positioned adjacent to the first heat exchanger 112 (e.g., downstream from the first heat exchanger 112 relative to the first airflow 124). In this way, the first vessel 108 receives the first airflow 124 and the solvent 106 present in the first vessel 108 absorbs or adsorbs greenhouse gas (e.g., CO₂) present in the first airflow 124 via a chemical process. In some embodiments, said chemical process involves transitioning the greenhouse gas (e.g., CO₂) to a liquid state. The flow device 105 of the greenhouse gas removal circuit 104 directs the solvent 106, now laden with the CO₂, for example, in the first solvent flow direction 111 from the first vessel 108 to the second vessel 110.

The second vessel 110 is positioned adjacent to the second heat exchanger 118 (e.g., downstream from the second heat exchanger 118 relative to the second airflow 126). In this way, the second vessel 110 receives heat rejected by the second heat exchanger 118 via the second airflow 126. The rejected heat drives a separation of the greenhouse gas (e.g., CO₂) present in the solvent 106 at the second vessel 110. For example, the CO₂ may include a boiling temperature that is less than that of the solvent 106. The greenhouse gas (e.g., CO₂) may be removed from the greenhouse gas removal circuit 104 via a removal conduit 128 fluidly coupling the second vessel 110 with a storage facility 130 (e.g., a storage vessel, a third vessel). In some embodiments, a greenhouse gas compressor 132 compresses the greenhouse gas (e.g., CO₂) between the second vessel 110 and the storage facility 130, as shown. In this way, greenhouse gas (e.g., CO₂) produced by the HVAC system 100 is contained, which reduces emissions by the HVAC system 100 relative to traditional configurations. Additionally or alternatively, the greenhouse gas (e.g., CO₂) is contained for future processing and/or usc.

As previously described, the HVAC system 100 may be operated in a normal operating mode, as illustrated in FIG. 5 and described above, or in a heat pump operating mode. The normal operating mode also may be referred to as a cooling mode and the heat pump mode also may be referred to as a heating mode in certain embodiments and/or configurations A controller 134 illustrated in FIG. 5, having processing circuitry 136 and memory circuitry 138, may operate to transition the HVAC system 100 between the normal operating mode and the heat pump operating mode. The memory circuitry 138 includes instructions stored thereon that, when executed by the processing circuitry 136, causing the controller 134 (e.g., by way of the processing circuitry 136) to perform various functions. For example, the memory circuitry 138 may include one or more memories, such as volatile memory (e.g., random-access memory or RAM) and/or non-volatile memory, such as read-only memory (ROM), optical drives, hard disc drives, solid-state drives, or any other non-transitory computer-readable medium that includes instructions (e.g., processor input instructions) to perform various functions, or any combination thereof. The processing circuitry 236 may include one or more application specific integrated circuits (ASICs), one or more field programmable gate arrays (FPGAs), one or more general purpose processors, or the like, or any combination thereof.

For example, the controller 134 may transition the HVAC system 100 between the normal operating mode and the heat pump operating mode based on feedback 140 and/or data received by the controller 134 from a thermostat, one or more sensors (e.g., temperature sensor, pressure sensor, humidity sensor, saturation sensor, etc.). The controller 134 may transition the HVAC system 100 between the normal operating mode and the heat pump operating mode by reversing at least a flow of the refrigerant 116 through the refrigeration circuit 102. Such flow reversal may be based on control of the expansion valve 120, the compressor 114, and/or a reversing valve 142 disposed in the refrigeration circuit 102. Likewise, in some embodiments, the controller 134 may operate to reverse a flow of the solvent 106 through the greenhouse gas removal circuit 104 (e.g., via control of an additional reversing valve 143, the flow device 105, such as a pump, or both) in response to the reversal of flow of the refrigerant 116 in the refrigeration circuit 102, such that the greenhouse gas removal features described above can be performed during the normal operating mode of the HVAC system 100 and the heat pump operating mode of the HVAC system 100.

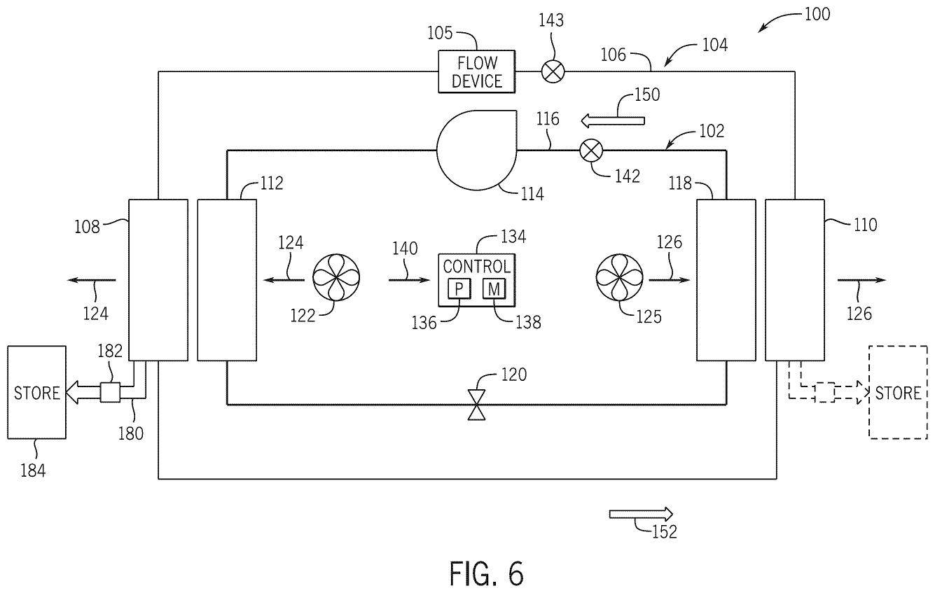

In some such embodiments, roles of the first vessel 108 and the second vessel 110 may be reversed between the normal operating mode of the HVAC system 100 and the heat pump operating mode of the HVAC system 100. For example, while the first vessel 108 operates as the absorber or adsorber vessel in FIG. 5 during the normal operating mode, the first vessel 108 may operate as the stripper during the heat pump operating mode. Further, while the second vessel 110 operates as the stripper in FIG. 5 during the normal operating mode, the first vessel 108 may operate as the absorber or adsorber vessel during the heat pump operating mode. FIG. 6 is a schematic view of an embodiment of an HVAC system, such as the HVAC system 100 of FIG. 5, operating in the heat pump operating mode. For example, a second refrigerant flow direction 150 of the refrigerant 116 in the refrigeration circuit 102 of FIG. 6 opposes the first refrigerant flow direction 117 of the refrigerant 116 in the refrigeration circuit 102 of FIG. 5, and a second solvent flow direction 152 of the solvent 106 in the greenhouse gas removal circuit 104 of FIG. 6 opposes the first solvent flow direction 111 of the solvent 106 in the greenhouse gas removal circuit 104 of FIG. 5. In embodiments where roles off the first vessel 108 and the second vessel 110 are switched between the normal operating mode and the heat pump operating mode, an additional removal conduit 180, an additional greenhouse gas compressor 182, and an additional storage facility 184 (e.g., additional third vessel, fourth vessel) may be employed (e.g., with the additional removal conduit 180 being coupled between the first vessel 108, acting as the stripper, and the additional storage facility 184), as shown in FIG. 6. In certain embodiments may include only one of the storage vessel 130 or additional storage vessel 184. Additionally or alternatively, a common storage facility (e.g., storage vessel) may be employed for both the normal operating mode and the heat pump operating mode in certain embodiments.

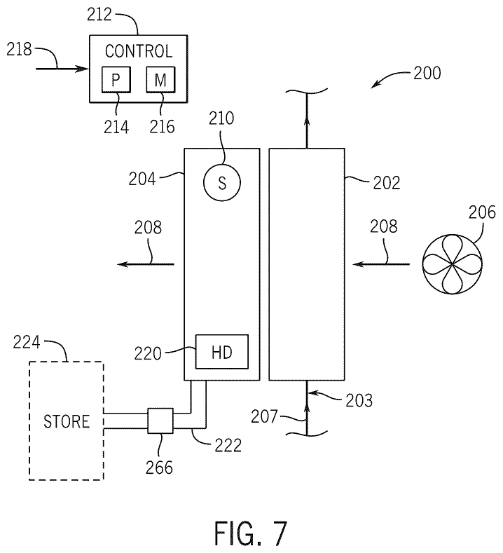

In FIGS. 5 and 6, the first airflow 124 may be biased toward a conditioned space to either cool the conditioned space or heat the conditioned space, depending on the operating mode of the HVAC system 100. In some embodiments, the first airflow 124 or a portion thereof may include a return air received from the conditioned space. Additionally or alternatively, a portion of the first airflow 124 or a separate airflow biased to the conditioned space may include ventilation air (e.g., outside air) employed for purposes of ventilation. As described above, presently disclosed embodiments of the HVAC system 100 may be better equipped for removing greenhouse gas emissions, such as CO₂ emissions, from the first airflow 124, which reduces an amount of ventilation air (e.g., outside air) needed for purposes of ventilation relative to traditional configurations. Because the ventilation air (e.g., outside air) may deviate from a setpoint characteristic (e.g., a setpoint temperature) by a greater amount than the return air, the reduction in ventilation air (e.g., outside air) of presently disclosed embodiments may reduce a load on the HVAC system 100, thereby improving an efficiency of the HVAC system 100 and/or reducing an operating cost of the HVAC system 100. The same or similar benefits may also apply to the embodiment illustrated in FIG. 7, described in detail below.

FIG. 7 is a schematic view of an embodiment of an HVAC system 200 including a heat exchanger 202 (e.g., an evaporator), which may form a part of a refrigeration circuit 203 (e.g., working fluid circuit) of the HVAC system 200, and a solid solvent vessel 204. While certain embodiments of the HVAC system 100 in FIGS. 5 and 6 may employ a liquid solvent (e.g., amine-based solvent), the embodiment of the HVAC system 200 in FIG. 7 may employ a solid solvent configured to absorb or adsorb, via a chemical process, greenhouse gas (e.g., CO₂) produced by the HVAC system 200. For example, the greenhouse gas (e.g., CO₂) may be removed from an airflow 208 generated by a fan 206 (e.g., blower) configured to direct the airflow 208 over the heat exchanger 202 to establish a heat exchange relationship between the airflow 208 and a refrigerant 207 associated with the refrigeration circuit 203.

As shown in FIG. 7, the solid solvent vessel 204 may be equipped with a sensor 210 configured to detect a saturation level at which the solid solvent in the solid solvent vessel 204 is saturated with or by the CO₂, for example. A controller 212 having processing circuitry 214 configured to execute instructions stored on memory circuitry 216 may receive sensor feedback 218 and/or data from the sensor and indicative of the saturation level. The controller 212 may transmit a signal indicative of the saturation level and/or in response to determining that the saturation level exceeds a threshold saturation level. The signal may indicate that maintenance or servicing of the solid solvent vessel 204 is needed. Additionally or alternatively, the solid solvent vessel 204 may be equipped with a heating device 220 configured to heat the solid solvent, now laden with CO₂, for example, such that the CO₂ is separated from the solid solvent for removal through a removal conduit 222 to a storage facility 224 (e.g., storage vessel). In some embodiments, a greenhouse gas compressor 226 may be employed to compress the removed greenhouse gas (e.g., CO₂) such that compressed greenhouse gas is delivered to the storage facility 224.

Further, it should be noted that in certain embodiments of the HVAC system 200 in FIG. 7, the solid solvent vessel 204 may be incorporated with, or form a part of, an air filter configured to filter other particulate, contaminants, etc. from the airflow 208. Further still, the solid solvent vessel 204 and/or air filter may be disposed downstream from the heat exchanger 202 relative to the airflow 208, as shown, or upstream from the heat exchanger 202 relative to the airflow 208.

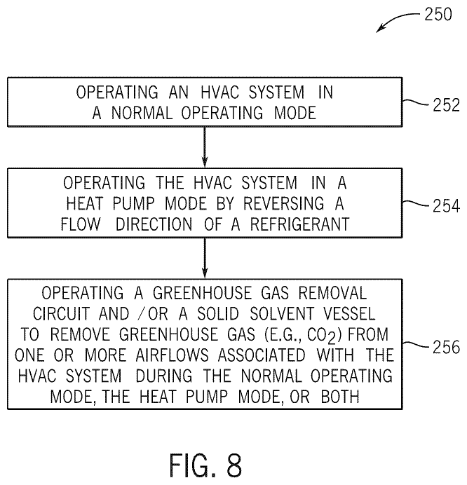

FIG. 8 is a process flow diagram illustrating an embodiment of a method 250 of operating an HVAC system including a vapor compression system (e.g., a refrigeration circuit) and a greenhouse gas removal circuit. The method 250 includes, for example, operating (block 252) the HVAC system in a normal operating mode, whereby a first heat exchanger corresponds to an evaporator and a second heat exchanger corresponds to a condenser in the normal operating mode. The method 250 also includes, for example, operating (block 254) the HVAC system in a heat pump operating mode by reversing a flow direction of a refrigerant, whereby the first heat exchanger corresponds to the condenser and the second heat exchanger corresponds to an evaporator in the heat pump operating mode.

The method 250 also includes, for example, operating (block 256) a greenhouse gas removal circuit and/or a solid solvent vessel to remove greenhouse gas (e.g., CO₂) from one or more airflows associated with the HVAC system during the normal operating mode, the heat pump operating mode, or both. In an embodiment employing a greenhouse gas removal circuit with a first vessel, a second vessel, and a solvent (e.g., liquid solvent, such as amine-based solvent), the first vessel may operate as an absorber or adsorber during the normal operating mode of the HVAC system and a stripper during the heat pump operating mode of the HVAC system, and the second vessel may operate as the stripper during the normal operating mode of the HVAC system and the absorber or adsorber during the heat pump operating mode of the HVAC system. Reversal of a flow direction of the solvent may be employed in certain embodiments to change the roles of the first vessel and the second vessel, as previously described. In an embodiment employing the solid solvent vessel, a solid solvent present in the solid solvent vessel may absorb or adsorb the CO₂, for example, where a signal is transmitted in response to a saturation level at which the solid solvent is saturated with or by the CO₂ exceeds a threshold saturation, or where a signal indicative of the saturation level is transmitted, or where a heating device (e.g., electrical heater) is powered on in response to the saturation level exceeding the threshold saturation, or any combination thereof.

Embodiments of the present disclosure reduce greenhouse gas emissions produced by HVAC systems relative to traditional embodiments, and/or enable a containment of such greenhouse gas for future processing and/or use. These and other aspects of the present disclosure are described in detail below.

Technical benefits of embodiments of the present disclosure include reduced greenhouse gas emissions, such as reduced CO₂ emissions, in addition to other possible technical benefits over traditional configurations.

While only certain features and embodiments of the disclosure have been illustrated and described, many modifications and changes may occur to those skilled in the art, such as variations in sizes, dimensions, structures, shapes and proportions of the various elements, values of parameters, including temperatures and pressures, mounting arrangements, use of materials, colors, orientations, and so forth without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be noted that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A heating, ventilation, and/or air conditioning (HVAC) system, comprising:
a refrigeration circuit comprising a first heat exchanger, a second heat exchanger, and at least one conduit configured to direct a refrigerant between the first heat exchanger and the second heat exchanger;
a first fan configured to direct a first airflow over the first heat exchanger;
a second fan configured to direct a second airflow over the second heat exchanger; and
a greenhouse gas removal circuit comprising a first vessel, a second vessel, and at least one additional conduit configured to direct a solvent between the first vessel and the second vessel, wherein:
the first vessel is positioned to receive the first airflow such that the solvent present in the first vessel absorbs or adsorbs a greenhouse gas present in the first airflow, and
the second vessel is positioned to receive the second airflow to facilitate separation of the greenhouse gas from the solvent present in the second vessel via heat rejected by the second heat exchanger.

2. The HVAC system of claim 1, wherein the solvent comprises a liquid solvent configured to absorb or adsorb carbon dioxide (CO₂) corresponding to the greenhouse gas.

3. The HVAC system of claim 2, wherein the liquid solvent comprises an amine-based solvent.

4. The HVAC system of claim 1, wherein:
the first vessel is positioned downstream of the first heat exchanger relative to a first flow direction of the first airflow, and
the second vessel is positioned downstream of the second heat exchanger relative to a second flow direction of the second airflow.

5. The HVAC system of claim 1, comprising a third vessel configured to receive, from the second vessel, the greenhouse gas removed from the solvent.

6. The HVAC system of claim 5, comprising a compressor configured to compress the greenhouse gas such that the third vessel receives the greenhouse gas in compressed form.

7. The HVAC system of claim 1, comprising a reversing valve configured to reverse a flow direction of the refrigerant through the refrigeration circuit such that:
the first heat exchanger operates as an evaporator and the second heat exchanger operates as a condenser in a normal operating mode of the HVAC system, and
the first heat exchanger operates as the condenser and the second heat exchanger operates as the evaporator in a heat pump operating mode of the HVAC system.

8. The HVAC system of claim 7, comprising a flow device, an additional reversing valve, or both configured to reverse an additional flow direction of the solvent through the greenhouse gas removal circuit in response to reversal of the flow direction of the refrigerant through the refrigeration circuit.

9. The HVAC system of claim 8, wherein:
the first vessel is configured to operate as an absorber or adsorber vessel in the normal operating mode and is configured to operate as a stripper in the heat pump operating mode; and
the second vessel is configured to operate as the stripper in the normal operating mode and is configured to operate as the absorber or adsorber vessel in the heat pump operating mode.

10. The HVAC system of claim 1, wherein the refrigeration circuit comprises:
a compressor positioned between the first heat exchanger and the second heat exchanger along a first side of the refrigeration circuit; and
an expansion valve positioned between the first heat exchanger and the second heat exchanger along a second side of the refrigeration circuit.

11. A method of operating a heating, ventilation, and/or air conditioning (HVAC) system, comprising:
establishing a first heat exchange relationship between a refrigerant present in a first heat exchanger of a refrigeration circuit of the HVAC system and a first airflow generated by a first fan of the HVAC system;
establishing a second heat exchange relationship between the refrigerant present in a second heat exchanger of the refrigeration circuit and a second airflow generated by a second fan of the HVAC system;
absorbing or adsorbing, from the first airflow, greenhouse gas via a solvent present in a first vessel of a greenhouse gas removal circuit of the HVAC system, wherein the first vessel is adjacent to the first heat exchanger;
biasing the solvent from the first vessel to a second vessel of the greenhouse gas removal circuit, wherein the second vessel is adjacent to the second heat exchanger; and
separating the greenhouse gas from the solvent at the second vessel via heat rejected by the second heat exchanger and present in the second airflow.

12. The method of claim 11, comprising controlling a reversing valve to reverse a flow direction of the refrigerant through the refrigeration circuit such that:
the first heat exchanger operates as an evaporator and the second heat exchanger operates as a condenser in a normal operating mode of the HVAC system; and
the first heat exchanger operates as the condenser and the second heat exchanger operates as the evaporator in a heat pump operating mode of the HVAC system.

13. The method of claim 12, comprising controlling a flow device, an additional reversing valve, or both to reverse an additional flow direction of the solvent through the greenhouse gas removal circuit in response to reversal of the flow direction of the refrigerant through the refrigeration circuit.

14. The method of claim 11, comprising:
biasing the refrigerant through the refrigeration circuit via a compressor; and
biasing the solvent through the greenhouse gas removal circuit via a pump.

15. The method of claim 11, comprising removing the greenhouse gas separated from the solvent via a removal conduit coupling the second vessel and a greenhouse gas storage facility.

16. The method of claim 15, comprising compressing the greenhouse gas via a greenhouse gas compressor such that the greenhouse gas storage facility receives the greenhouse gas in compressed form.

17. The method of claim 11, wherein the solvent includes an amine-based solvent.

18. A heating, ventilation, and/or air conditioning (HVAC) system, comprising:
a heat exchanger;
a fan configured to direct an airflow over the heat exchanger; and
a vessel positioned adjacent to the heat exchanger, wherein the vessel is configured to:
receive the airflow directed across the heat exchanger; and
absorb or adsorb a greenhouse gas within the airflow in a solid solvent present in the vessel.

19. The HVAC system of claim 18, comprising a sensor configured to detect a saturation level of greenhouse gas absorbed or adsorbed by the solid solvent.

20. The HVAC system of claim 19, comprising a controller configured to:
receive, from the sensor, data indicative of the saturation level; and
transmit a signal indicative of the saturation level in response to the saturation level exceeding a threshold saturation level.
